(19) United States
(12) Patent Application Publication
(10) Pub. No.: US 2016/0295380 A1
(43) Pub. Date: Oct. 6, 2016

(54) MULTICAST SUB-GROUPING METHODS FOR WIRELESS COMMUNICATIONS

(71) Applicant: QUALCOMM Incorporated, San Diego, CA (US)

(72) Inventors: Vijayaraja Pitchaiah, Thanjavur (IN); Shan Palanisamy, Chennai (IN); Ranga Rao Ravuri, Chennai (IN)

(21) Appl. No.: 14/678,728

(22) Filed: Apr. 3, 2015

(51) Int. Cl. H04W 4/08; H04L 29/06; H04L 1/16

(52) U.S. Cl. CPC H04W 4/08; H04L 1/16; H04L 65/4076

(57) ABSTRACT

Methods, systems, and devices are described for wireless communication at an access point (AP). The AP may determine a multicast grouping metric for a wireless station based at least in part on a channel condition associated with the wireless station and a data rate capability of the wireless station. The AP may assign the wireless station to a multicast subgroup based at least in part on the multicast grouping metric of the wireless station. The AP may transmit multicast transmissions to the multicast subgroup at a streaming rate based at least in part on the assigned multicast subgroup.

### BACKGROUND

1. Field of the Disclosure

The present disclosure relates to wireless communication systems, and more particularly to grouping wireless stations into subgroups for multicast transmissions.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include an access point (AP) that may communicate with one or more stations (STAs) or wireless stations. The AP may be coupled to a network, such as the Internet, and enable a wireless station to communicate via the network (and/or communicate with other devices coupled to the access point). The AP may communication with a wireless station independently (unicast transmissions) or with multiple wireless stations interested in receiving the same content (multicast transmissions).

An AP may send multicast transmissions to wireless stations that are located within its coverage area. Wireless stations located near the AP tend to have better channel conditions than wireless stations located at the edge of the coverage area. The improved channel conditions generally provide for higher available throughput rates for the wireless stations. Furthermore, wireless stations may be configured to support varying data rates that may, or may not be commensurate with data rates offered by the AP. For example, a legacy wireless station may be configured to support data rates as high as 300 Mbps (e.g., data rates associated with IEEE 802.11n standards) whereas newer wireless stations may support data rates up to 1.300 Gbps (e.g., data rates associated with IEEE 802.11ac standards). Accordingly, and in addition to the channel conditions the wireless station is experiencing, the configuration of the wireless station (e.g., the wireless station hardware configuration, version configuration, etc.) may determine which throughput rates the wireless station can support.

For unicast transmissions, streaming rates are typically tailored for the individual wireless station's circumstances, e.g., channel conditions. Accordingly, the AP may optimize transmissions of unicast content to the wireless station. For multicast transmissions, however, the AP generally selects a lowest data rate for the multicast transmissions to ensure each wireless station is capable of receiving the multicast transmission. The AP may select the lowest streaming rate based at least in part on the worst experienced channel conditions by a wireless station. In some examples, however, the lowest data rate multicast streaming rate may not support steaming of high-definition content. Accordingly, wireless stations located near the AP may not be able to receive multicast streaming of high-definition content due to the lowest data rate selection scheme adopted by the access point.

### SUMMARY

The present description generally relates to one or more improved systems, methods, apparatuses, or computer-readable media for wireless communications. More particularly, an improved multicast transmission scheme that partitions wireless stations into multicast subgroups is described. Generally, the AP may determine a multicast grouping metric for each wireless station. The multicast grouping metric may be based at least in part on a channel condition associated with the wireless station as well as the data rate capability of the wireless station, e.g., the data rate capability the wireless station is designed or otherwise configured to support. The AP may assign the wireless station to one of a plurality of multicast subgroups based at least in part on the multicast grouping metric, e.g., assign the wireless station to a multicast subgroup with other wireless station having a similar multicast grouping metric. The AP may transmit multicast transmissions to the wireless station at a streaming rate based at least in part on the assigned multicast subgroup. The AP may determine the multicast grouping metric for the wireless station over a predetermined time period, e.g., based at least in part on monitoring the channel conditions for the wireless station for a certain period of time or over a time window.

A method for wireless communication is described. The method may include: determining a multicast grouping metric for a wireless station, the multicast grouping metric based at least in part on a channel condition associated with the wireless station and a data rate capability of the wireless station; assigning the wireless station to one of a plurality of multicast subgroups based at least in part on the multicast grouping metric; and transmitting a multicast transmission to the wireless station at a streaming rate based at least in part on the assigned multicast subgroup.

The method may include determining the multicast grouping metric for the wireless station over a predetermined time period. The method may include transmitting, prior to transmission of the multicast transmission, a message to the wireless station indicating the one of the multicast subgroups to which the wireless station is assigned. The method may include: determining that the multicast grouping metric for the wireless station has changed; and assigning the wireless station to a different multicast subgroup based at least in part on the changed multicast grouping metric.

The method may include: determining the plurality of multicast subgroups based at least in part on multicast grouping metrics associated with a plurality of wireless stations within a coverage area of an access point; and transmitting multicast messages to different ones of the multicast subgroups using different streaming rates. The data rate capability of the wireless station may be based at least in part on a maximum streaming rate the wireless station is adapted to support. The multicast grouping metric may further based at least in part on a signal strength for the wireless station, a packet error rate for communications with the wireless station, a quantity of acknowledgement or negative acknowledgement (ACK/NACK) messages received from the wireless station, a message retransmission length for communications with the wireless station, or combinations thereof.

The method may include: determining that the wireless station has been idle for a predetermined time period; transmitting a polling message to the wireless station; and determining the multicast grouping metric for the wireless station based at least in part on the polling message.

An apparatus for wireless communications is described. The apparatus may include: a multicast grouping metric controller to determine a multicast grouping metric for a wireless station, the multicast grouping metric based at least in part on a channel condition associated with the wireless station and a data rate capability of the wireless station; a multicast subgroup manager to assign the wireless station to one of a plurality of multicast subgroups based at least in part on the multicast grouping metric; and a multicast transmission controller to transmit a multicast transmission to the wireless station at a streaming rate based at least in part on the assigned multicast subgroup.

The multicast grouping metric controller is further to determine the multicast grouping metric for the wireless station over a predetermined time period. The multicast transmission controller is further to transmit, prior to transmission of the multicast transmission, a message to the wireless station indicating the one of the multicast subgroups to which the wireless station is assigned. The multicast grouping metric controller is further to determine that the multicast grouping metric for the wireless station has changed; and wherein the multicast subgroup manager is further to assign the wireless station to a different multicast subgroup based at least in part on the changed multicast grouping metric.

The multicast subgroup manager is further to determine the plurality of multicast subgroups based at least in part on multicast grouping metrics associated with a plurality of wireless stations within a coverage area of an access point; and wherein the multicast transmission controller is further to transmit multicast messages to different ones of the multicast subgroups using different streaming rates. The data rate capability of the wireless station is based at least in part on a maximum streaming rate the wireless station is adapted to support. The multicast grouping metric is further based at least in part on a signal strength for the wireless station, a packet error rate for communications with the wireless station, a quantity of acknowledgement or negative acknowledgement (ACK/NACK) messages received from the wireless station, a message retransmission length for communications with the wireless station, or combinations thereof.

The multicast transmission controller is further to determine that the wireless station has been idle for a predetermined time period; to transmit a polling message to the wireless station; and wherein the multicast grouping metric controller is further to determine the multicast grouping metric for the wireless station based at least in part on the polling message.

An apparatus for wireless communication is described. The apparatus may include: means for determining a multicast grouping metric for a wireless station, the multicast grouping metric based at least in part on a channel condition associated with the wireless station and a data rate capability of the wireless station; means for assigning the wireless station to one of a plurality of multicast subgroups based at least in part on the multicast grouping metric; and means for transmitting a multicast transmission to the wireless station at a streaming rate based at least in part on the assigned multicast subgroup.

The apparatus may include means for determining the multicast grouping metric for the wireless station over a predetermined time period. The apparatus may include means for transmitting, prior to transmission of the multicast transmission, a message to the wireless station indicating the one of the multicast subgroups to which the wireless station is assigned. The apparatus may include means for determining that the multicast grouping metric for the wireless station has changed; and means for assigning the wireless station to a different multicast subgroup based at least in part on the changed multicast grouping metric.

The apparatus may include: means for determining the plurality of multicast subgroups based at least in part on multicast grouping metrics associated with a plurality of wireless stations within a coverage area of an access point; and means for transmitting multicast messages to different ones of the multicast subgroups using different streaming rates. The data rate capability of the wireless station is based at least in part on a maximum streaming rate the wireless station is adapted to support. The multicast grouping metric is further based at least in part on a signal strength for the wireless station, a packet error rate for communications with the wireless station, a quantity of acknowledgement or negative acknowledgement (ACK/NACK) messages received from the wireless station, a message retransmission length for communications with the wireless station, or combinations thereof.

The apparatus may include: means for determining that the wireless station has been idle for a predetermined time period; means for transmitting a polling message to the wireless station; and means for determining the multicast grouping metric for the wireless station based at least in part on the polling message.

A non-transitory computer-readable medium storing code for communication at a wireless device is described. The code comprising instructions executable by a processor to cause the wireless device to: determine a multicast grouping metric for a wireless station, the multicast grouping metric based at least in part on a channel condition associated with the wireless station and a data rate capability of the wireless station; assign the wireless station to one of a plurality of multicast subgroups based at least in part on the multicast grouping metric; and transmit a multicast transmission to the wireless station at a streaming rate based at least in part on the assigned multicast subgroup.

The non-transitory computer-readable medium further comprising code executable by the processor to: determine the multicast grouping metric for the wireless station over a predetermined time period. The non-transitory computer-readable medium further comprising code executable by the processor to transmit, prior to transmission of the multicast transmission, a message to the wireless station indicating the one of the multicast subgroups to which the wireless station is assigned. The non-transitory computer-readable medium further comprising code executable by the processor to: determine that the multicast grouping metric for the wireless station has changed; and assign the wireless station to a different multicast subgroup based at least in part on the changed multicast grouping metric.

The non-transitory computer-readable medium further comprising code executable by the processor to: determine the plurality of multicast subgroups based at least in part on multicast grouping metrics associated with a plurality of wireless stations within a coverage area of an access point; and transmit multicast messages to different ones of the multicast subgroups using different streaming rates. The non-transitory computer-readable medium wherein the data rate capability of the wireless station is based at least in part on a maximum streaming rate the wireless station is adapted to support.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 shows a diagram of wireless station multicast subgrouping in a wireless communication system, in accordance with various aspects of the present disclosure;

FIG. 3 shows a diagram of wireless station multicast subgrouping in a wireless communication system, in accordance with various aspects of the present disclosure;

FIG. 4 illustrates an example of wireless communications between an access point and a wireless station, in accordance with various aspects of the present disclosure;

FIG. 5 illustrates an example of wireless communications between an access point and a wireless station, in accordance with various aspects of the present disclosure;

FIG. 6 shows a block diagram of a device configured for use in wireless communication, in accordance with various aspects of the present disclosure;

FIG. 7 shows a block diagram of a device configured for use in wireless communication, in accordance with various aspects of the present disclosure;

FIGS. 8A and 8B show block diagrams of wireless communication systems, in accordance with various aspects of the present disclosure;

FIG. 9 is a flow chart illustrating an example of a method for wireless communication, in accordance with various aspects of the present disclosure;

FIG. 10 is a flow chart illustrating an example of a method for wireless communication, in accordance with various aspects of the present disclosure; and

FIG. 11 is a flow chart illustrating an example of a method for wireless communication, in accordance with various aspects of the present disclosure.

### DETAILED DESCRIPTION

Multicast transmissions permit an AP to send a single transmission of content to more than one wireless station. For example, the AP may stream video, audio, or other content to wireless stations interested in receiving such content. When selecting a streaming rate for the multicast transmission, the AP will typically adopt a worst-case scenario approach. For example, the AP may determine which wireless station has the worst channel conditions and stream the multicast content to all wireless stations at a streaming rate determined based at least in part on the worst reported channel conditions. While this scheme may ensure reception of the multicast content for all wireless stations, it may also introduce limitations. For example, certain high-definition video content may not be supported as it may require a faster streaming rate than the worst channel conditions can support. As another example, wireless stations experiencing good channel conditions, and therefore able to support higher streaming rates, would otherwise be limited to the lowest streaming rate.

The AP will typically determine the lowest streaming rate based at least in part on channel conditions reported by the wireless stations. The channel conditions reporting may include a received signal strength indicator (RSSI), channel quality indicator (CQI), packet error rate (PER), acknowledgement/negative acknowledgement (ACK/NACK) frequency, and the like. However, the wireless station configuration may also impact the streaming rate it can support. For example, a new high throughput (HT) or very high throughput (VHT) wireless station will likely be able to support any streaming rate the AP can provide. A legacy wireless station, e.g., an older wireless station or a wireless station with outdated firmware, operating system, etc., may not be able to support some higher streaming rates. Current multicast streaming rate determination schemes typically do not consider the wireless station configuration.

The present description generally relates to improved systems, methods, apparatuses, or computer-readable media for wireless communication by an AP. Generally, the present description provides for grouping wireless stations into multicast subgroups based at least in part on the channel conditions the wireless station is experiencing to the AP as well as the configuration of the wireless station, e.g., which streaming rates the wireless station can support. For example, the AP may determine a metric for the wireless station for multicast subgrouping by considering the channel conditions the wireless station is reporting as well as which streaming rate the wireless station is configured or otherwise adapted to support. As one example, a legacy wireless station otherwise experiencing good channel conditions may not be able to support a streaming rate commensurate with its channel conditions. The AP may assign the wireless station to the multicast subgroup and transmit the multicast transmission at a streaming rate associated with the multicast subgroup. Wireless stations within a particular multicast subgroup may receive the transmission at the same streaming rate. Wireless stations within a different multicast subgroup will receive the multicast transmissions at a different streaming rate. Accordingly, the AP may have more flexibility in selecting a streaming rate for multicast transmissions.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

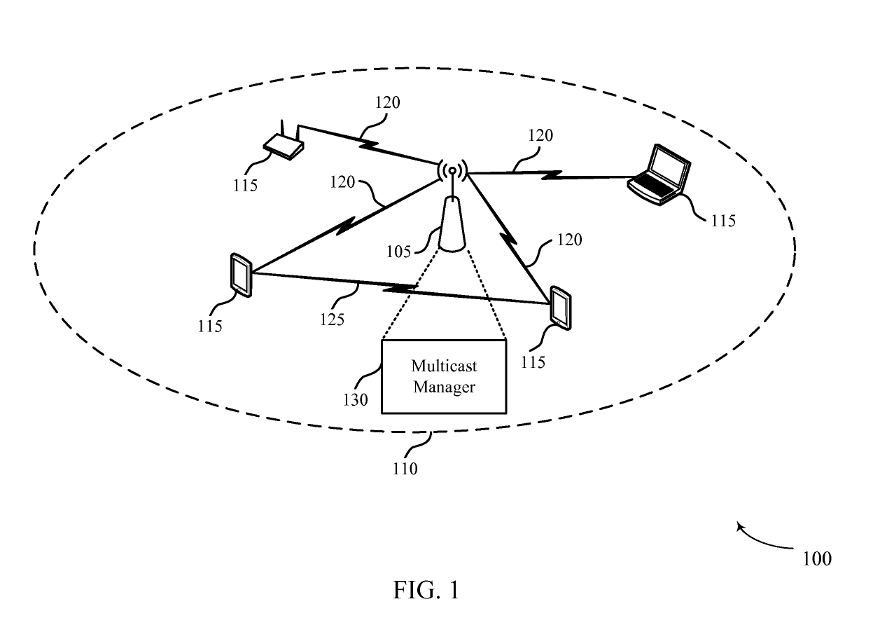

Referring first to FIG. 1, a block diagram illustrates an example of a WLAN network 100 such as, e.g., a network implementing at least one of the IEEE 802.11 family of standards. The WLAN network 100 may include an access point (AP) 105 and one or more wireless devices or stations (STAs) 115, such as mobile stations, client devices, personal digital assistants (PDAs), other handheld devices, netbooks, notebook computers, tablet computers, laptops, display devices (e.g., TVs, computer monitors, etc.), printers, etc. While only one AP 105 is illustrated, the WLAN network 100 may have multiple APs 105. Each of the wireless stations 115, which may also be referred to as mobile stations (MSs), mobile devices, access terminals (ATs), user equipment (UE), subscriber stations (SSs), or subscriber units, may associate and communicate with an AP 105 via a communication link 120. Each AP 105 has a geographic coverage area 110 such that STAs 115 within that area can typically communicate with the AP 105. The STA 115 may be dispersed throughout the geographic coverage area 110. Each STA 115 may be stationary or mobile.

Although not shown in FIG. 1, a STA 115 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A geographic coverage area 110 for an access point 105 may be divided into sectors making up only a portion of the coverage area (not shown). The WLAN network 100 may include access points 105 of different types (e.g., metropolitan area, home network, etc.), with varying sizes of coverage areas and overlapping coverage areas for different technologies. Although not shown, other wireless devices can with the AP 105.

While the STAs 115 may communicate with each other through the AP 105 using communication links 120, each STA 115 may also communicate directly with one or more other STAs 115 via a direct wireless link 125. Two or more STAs 115 may communicate via a direct wireless link 125 when both STAs 115 are in the AP geographic coverage area 110 or when one or neither STA 115 is within the AP geographic coverage area 110 (not shown). Examples of direct wireless links 125 may include Wi-Fi Direct connections, connections established by using a Wi-Fi Tunneled Direct Link Setup (TDLS) link, and other P2P group connections. The wireless stations 115 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within WLAN network 100.

AP 105 may include a multicast manager 130 that monitors, controls, or otherwise manages aspects of multicast subgrouping for the AP 105. The multicast manager 130 may assign STA 115 to multicast subgroups based at least in part on the channel conditions the STA 115 is experiencing and a data rate the STA 115 can support. For example, the AP 105 may determine a metric for the STA 115 that considers, among other factors, the channel conditions being reported by the STA 115 and the configuration of the STA 115. The metric may provide a comprehensive indication of a streaming rate the STA 115 can support for multicast transmissions. The AP 105 may assign the STA 115 to one of several multicast subgroups based at least in part on the metric. For example, STAs 115 with a metric between a first set of metric ranges may be assigned to a first multicast subgroup, STAs 115 with a metric between a second set of metric ranges may be assigned to a second multicast subgroup, and so forth. Each STA 115 within a given multicast subgroup may receive the multicast transmissions at a common streaming rate. The common streaming rate for the multicast subgroup may be selected to provide reception by all STAs 115 within the multicast subgroup. Accordingly, the AP 105 may provide for a more refined level of abstraction for multicast transmissions to STAs 115 within the AP geographic coverage area 110.

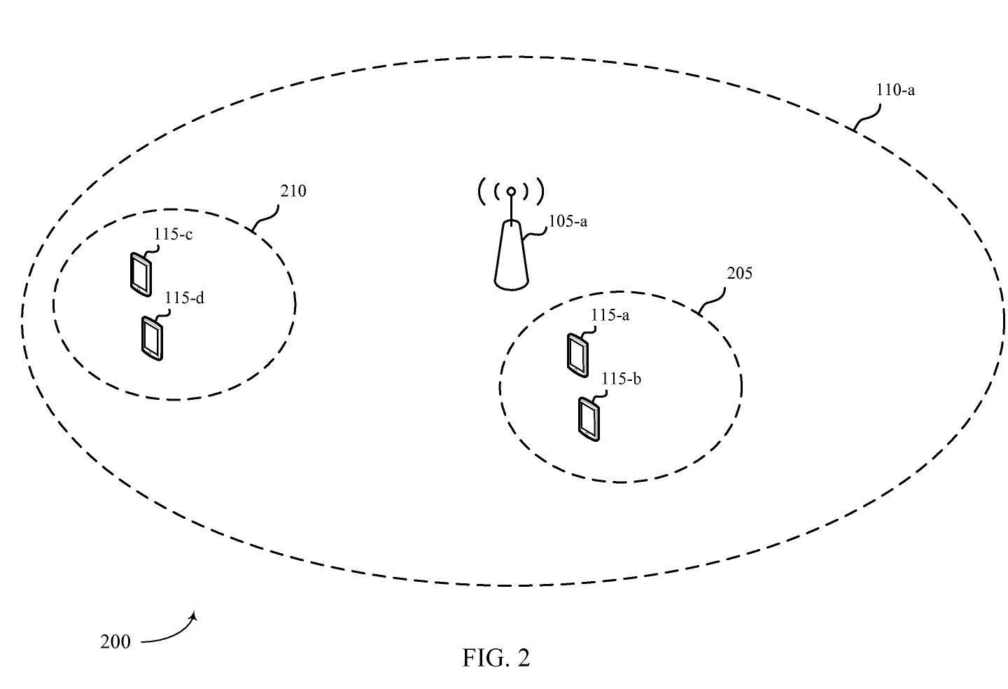

FIG. 2 shows a diagram of a wireless communications system 200 illustrating an example of multicast subgrouping in a wireless network, in accordance with various aspects of the present disclosure. The wireless communications system 200 may include an AP 105-a, STA 115-a, STA 115-b, STA 115-c, and/or STA 115-d. The STAs 115-a, 115-b, 115-c, and/or 115-d may be examples of a STA 115 described with reference to FIG. 1. The AP 105-a may be an example of the AP 105 described with reference to FIG. 1. Generally, wireless communications system 200 illustrates aspects of the AP 105-a grouping STAs 115 into different multicast subgroups.

AP 105-a may have a geographic coverage area 110-a such that STAs 115 within that area can typically communicate with the AP 105-a. The STAs 115 may be dispersed throughout the geographic coverage area 110-a. For example, STA 115-a and STA 115-b may be positioned near the AP 105-a whereas STA 115-c and STA 115-d may be positioned farther from AP 105-a and closer to the edge of the geographic coverage area 110-a.

According to traditional multicast transmission schemes, the AP 105-a would typically monitor channel conditions for each STA 115 to determine which streaming rate the STA 115 can support. In the example wireless communications system 200, STA 115-a and STA 115-b may experience better channel conditions than STA 115-c and STA 115-d and, therefore, support higher multicast streaming rates. However, the AP 105-a would typically transmit multicast content to all STAs 115 at a streaming rate based at least in part on the channel conditions experienced and reported by STA 115-c and/or STA 115-d.

The present description, however, provides for the AP 105-a to assign the STAs 115 within its geographic coverage area 110-a to different multicast subgroups, each multicast subgroup associated with a different streaming rate. AP 105-a may determine that STA 115-a and STA 115-b are reporting similar channel conditions, e.g., RSSI values within a predefined range. AP 105-a may also determine that STA 115-c and STA 115-d are also reporting similar channel conditions, albeit different than the channel conditions being reported by STA 115-a and STA 115-b. The AP 105-a may monitor and determine the channel conditions over a predetermined time period, e.g., to account for sudden and short-lived changes in the reported channel conditions. Additional information that may be associated with or indicative of the channel conditions for the STAs 115 include a packet error rate, a number of acknowledgement/negative acknowledgement (ACK/NACK) messages received within a time frame, etc.

Moreover, AP 105-a may determine a configuration for the STAs 115 within its geographic coverage area 110-a that provides an indication of which streaming rates the STAs 115 may support. For example, AP 105-a may determine the streaming rate (or data rate) capability for each STA 115 during an association request/response procedure where the STA 115 registers (or re-registers) with the AP 105-a for service. As can be appreciated, some STAs 115 may be older wireless stations and not support every possible streaming rate the AP 105-a is able to provide due to hardware limitations, software limitations, firmware limitations, etc.

Therefore, the AP 105-a may determine a metric for the STA 115 based at least in part on its reported channel condition and its streaming (or data) rate capability. The metric may be equally balanced (e.g., where the channel conditions are afforded the same level of importance as the streaming rate capability) or one factor may carry more weight than the other (e.g., the streaming rate capability may carry more weight than the channel condition, or vice versa). In some examples, the streaming rate capability of the STA 115 may be an important factor for determining the metric.

The AP 105-a may assign the STAs 115 within its geographic coverage area 110-a to at least one multicast subgroup. As illustrated in FIG. 2, AP 105-a may assign STA 115-a and STA 115-b to a first multicast subgroup 205 and STA 115-c and STA 115-d to a second multicast subgroup 210. Although FIG. 2 shows two multicast subgroups, it is to be understood that more multicast subgroups may also be defined by AP 105-a. In some examples, AP 105-a may dynamically change the number of multicast subgroups available for assignment based at least in part on changing conditions within its geographic coverage area 110-a, e.g., due to STA 115 mobility, STA 115 joining or leaving the geographic coverage area 110-a, etc. In examples where many (e.g., hundreds) of STAs 115 are within the geographic coverage area 110-a and interested in receiving multicast transmissions, AP 105-a may choose to have a large number of multicast subgroups available. Other considerations as to the number of available multicast subgroups may include, but are not limited to, a quantity of channels or frequency bands available for multicast transmissions, a bandwidth of the available channels or frequency bands available for multicast transmissions, a congestion level of the AP 105-a and wireless communications system 200, etc.

The first multicast subgroup 205 may be associated with receiving multicast transmissions at a first streaming rate, whereas the second multicast subgroup 210 may be associated with receiving multicast transmissions at a second streaming rate. The first and second streaming rates may be different. In one example, the streaming rate for STAs 115 assigned to the first multicast subgroup 205 may be faster than the streaming rate for STAs 115 assigned to the second multicast subgroup 210.

While the STAs 115 assigned to a given multicast subgroup may experience similar channel conditions and streaming rate capabilities, it is to be understood that some STAs 115 within the multicast subgroup may experience channel conditions associated with a different streaming rate than other STAs 115 within the multicast subgroup. As one non-limiting example, a first STA 115 may support a streaming rate based at least in part on a modulation-coding scheme (MCS) of 9×3, a second STA 115 may support a streaming rate based at least in part on a MCS of 7×3, and a third STA 115 may support a streaming rate based at least in part on a MCS of 7×1. To ensure reception of the multicast content by all STAs 115 within the given multicast subgroup, AP 105-a may select a streaming rate for the multicast subgroup based at least in part on a MCS of 7×1. In some examples, AP 105-a may select a streaming rate based at least in part on a MCS of 6×1 to provide added assurance of multicast transmission reception.

AP 105-a may also reassign a STA 115 from a first multicast subgroup 205 to a second multicast subgroup 210 due to changing channel conditions, for example. AP 105-a may monitor the channel conditions being reported by the STA 115 over a predetermined time period and determine that the reported channel condition has changed by a predetermined amount, that the reported channel condition meets a predetermined rate of change, etc. Accordingly, AP 105-a may determine that the STA 115 is no longer a suitable candidate for its current multicast subgroup assignment and therefore reassign the STA 115 to a different multicast subgroup.

AP 105-a may also inform the STAs 115 within its geographic coverage area 110-a of which multicast subgroup they have been assigned to. AP 105-a may send the message informing the STA 115 of its multicast subgroup assignment prior to sending the first multicast transmission. For a STA 115 that has been reassigned to a different multicast subgroup, AP 105-a may also send a message informing the STA 115 of the newly assigned multicast subgroup. In some examples, AP 105-a may send the message informing the STA 115 of its multicast subgroup assignment a predetermined number of beacon transmissions before the multicast transmission. AP may use one or more information elements within a beacon to signal the multicast subgroup assignment.

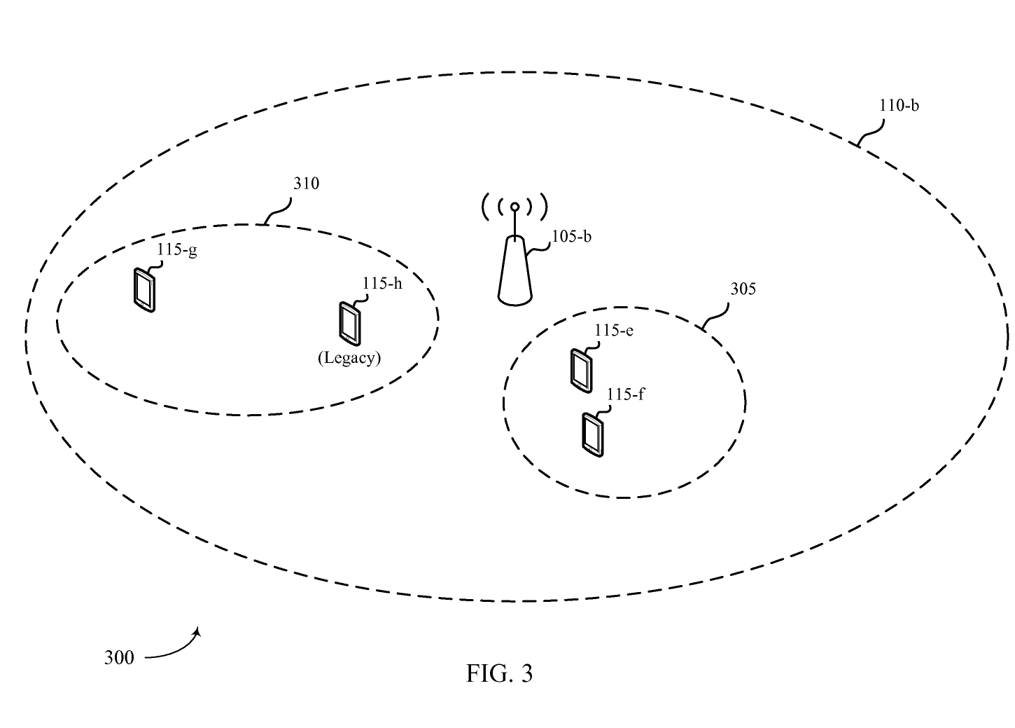

FIG. 3 shows a diagram of a wireless communications system 300 illustrating an example of multicast subgrouping in a wireless network, in accordance with various aspects of the present disclosure. The wireless communications system 300 may include an AP 105-b, STA 115-e, STA 115-f, STA 115-g, and/or STA 115-h. The STAs 115-e, 115-f, 115-g, and/or 115-h may be examples of a STA 115 described with reference to FIG. 1. The AP 105-b may be an example of the AP 105 described with reference to FIG. 1. Generally, wireless communications system 300 illustrates aspects of the AP 105-b grouping STAs 115 into different multicast subgroups.

Generally, AP 105-b is similar to, and may perform the same functions as AP 105-a described with respect to FIG. 2. However, wireless communications system 300 illustrates an additional aspect of the present description where the streaming (or data) rate capability of the STA 115 may impact which multicast subgroups the STA 115 might be assigned to.

As illustrated in FIG. 3, STA 115-e, STA 115-f, and STA 115-h may be positioned closer to AP 105-b than STA 115-g. For example, STA 115-e, STA 115-f, and STA 115-h may be experiencing and reporting similar channel conditions (or at least channel conditions within a predetermined range). STA 115-g may be reporting channel conditions that might be considered less favorable than those being reported by STA 115-e, STA 115-f, and STA 115-h, e.g., lower RSSI value. Accordingly, the channel conditions being reported by STA 115-g may support a lower streaming rate for STA 115-g than can be provided to STA 115-e, STA 115-f, and STA 115-h.

However, STA 115-h may be a legacy wireless station and therefore may not support a streaming rate commensurate with its reported channel conditions or a streaming rate that AP 105-b is able to provide. For example, STA 115-h may be an older wireless station, may use software/firmware that does not support higher streaming rates, etc. Accordingly, AP 105-b may determine a metric for STA 115-h that is similar to (or within a predefined range) the metric determined for STA 115-g, despite the fact that STA 115-h channel conditions might otherwise support a faster streaming rate. Consequently, AP 105-b may assign the STA 115-g and STA 115-h to a second multicast subgroup 310 and assign STA 115-e and STA 115-f to a first multicast subgroup 305. The second multicast subgroup 310 may be associated with a lower streaming rate for multicast transmissions than the streaming rate associated with the first multicast subgroup 305.

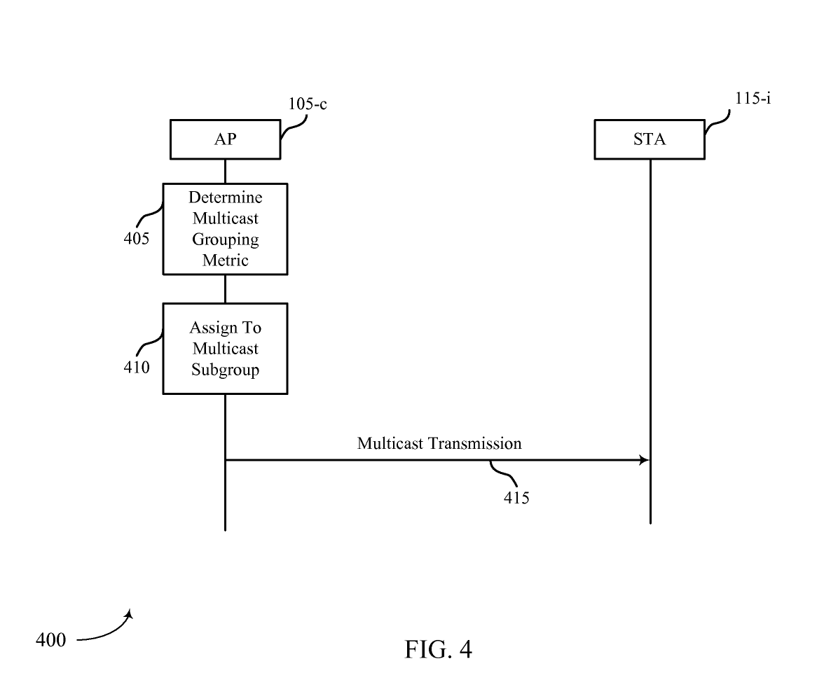

FIG. 4 illustrates an example of a wireless communication 400 between an AP 105-c and a STA 115-i, in accordance with various aspects of the present disclosure. The AP 105-c may be an example of an AP 105 described with reference to FIGS. 1-3, and the STA 115-i may be an example of a STA 115 described above with reference to FIGS. 1-3. Generally, the wireless communication 400 illustrates aspects of multicast subgroup assignment for the STA 115-i.

At block 405, AP 105-c may determine a multicast grouping metric for the STA 115-i. The multicast grouping metric may be based at least in part on channel conditions associated with the STA 115-i, e.g., the channel conditions the STA 115-i is reporting or otherwise indicating (RSSI, PER, ACK/NACK) to the AP 105-c. The multicast grouping metric may also be based at least in part on a data (or streaming) rate capability of the STA 115-i, e.g., the data rate the STA 115-i is configured to support based at least in part on hardware, software, firmware, etc., of the STA 115-i. Generally, the multicast grouping metric may provide a comprehensive indication of a streaming rate for multicast transmissions for STA 115-i.

At block 410, AP 105-c may assign the STA 115-i to a multicast subgroup based at least in part on the multicast grouping metric. For example, AP 105-c may determine that the multicast grouping metric is within a given range of multicast grouping metrics and assign the STA 115-i to the multicast subgroup associated with the given range of multicast grouping metrics. The multicast subgroup the STA 115-i is assigned to may be associated with a given multicast streaming rate.

At 415, AP 105-c may transmit one or more multicast transmissions to the STA 115-i at the streaming rate associated with the assigned multicast subgroup. Accordingly, AP 105-c may provide multicast content transmissions to the STA 115-i at a streaming rate that is more reflective of the optimal streaming rate the STA 115-i is able to support, given its associated channel conditions and data rate capability.

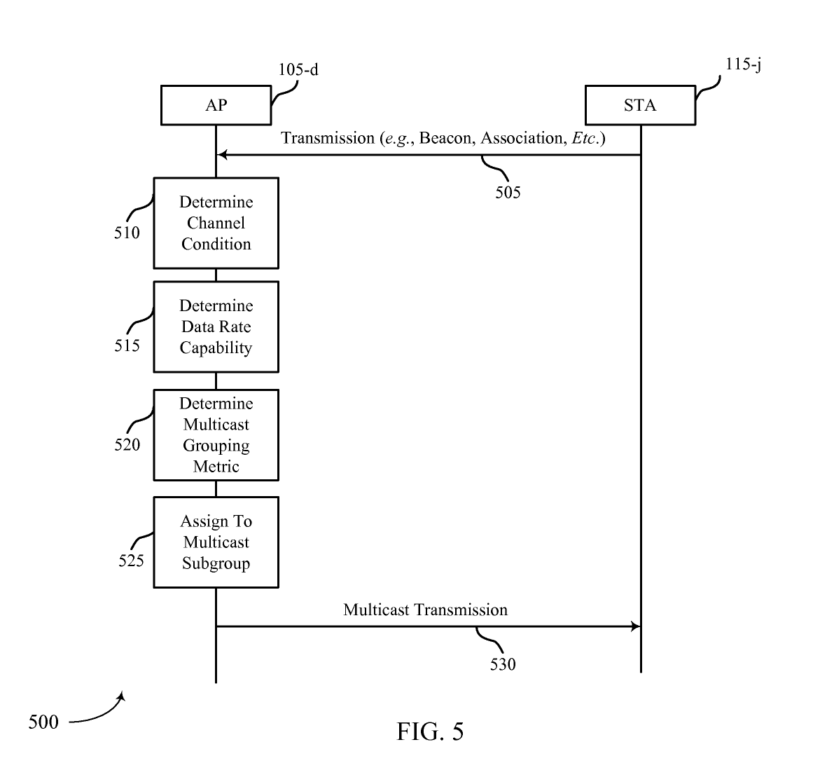

FIG. 5 illustrates an example of a wireless communication 500 between an AP 105-d and a STA 115-j, in accordance with various aspects of the present disclosure. The AP 105-d may be an example of an AP 105 described with reference to FIGS. 1-3, and the STA 115-j may be an example of a STA 115 described above with reference to FIGS. 1-3. Generally, the wireless communication 500 illustrates aspects of multicast subgroup assignment for the STA 115-j.

At 505, the STA 115-j may send one or more transmissions to the AP 105-d. The transmissions may be a beacon signal, an association request message, or any other transmission that conveys at least one of a channel condition associated with the STA 115-j and/or a data rate capability of the STA 115-j.

At block 510, AP 105d may determine a channel condition for the STA 115-j. The AP 105-d may determine the channel condition based at least in part on the transmission received at 505. The transmission may carry channel condition information associated with the STA 115-j. For example, the channel condition may be a reported RSSI value, CQI, etc., or any indication of channel conditions associated with communications between AP 105-d and STA 115-j. Additionally, the channel condition information may include one or more ACK/NACK messages whereas the AP 105-d determines the channel conditions of the STA 115-j based at least in part on the ACK/NACK messages, PER, etc.

At block 520, AP 105-d may determine a data rate capability for the STA 115-j. AP 105-d may determine the data rate capability based at least in part on the transmission received at 505. For example, the transmission may also convey an indications of the data (or streaming) rate capability for the STA 115-j. The data rate capability may be determined or otherwise based at least in part on a hardware configuration, a software/firmware version, etc., of the STA 115-j. The data rate capability may also be determined based at least in part on a subscription level of the STA 115-j. For example, the user of the STA 115-j may subscribe to a service for communicating via AP 105-j that includes a maximum data rate capability the STA 115-j is permitted to receive. Generally, the data rate capability of the STA 115-j is an independent factor with respect to the channel conditions associated with the STA 115-j.

At block 520, AP 105-d may determine a multicast grouping metric for the STA 115-j. The multicast grouping metric may be based at least in part on channel conditions associated with the STA 115-j and the data (or streaming) rate capability of the STA 115-j. Generally, the multicast grouping metric may provide a comprehensive indication of a streaming rate for multicast transmissions for STA 115-j.

At block 525, AP 105-d may assign the STA 115-j to a multicast subgroup based at least in part on the multicast grouping metric. For example, AP 105-d may determine that the multicast grouping metric is within a given range of multicast grouping metrics and assign the STA 115-j to the multicast subgroup associated with the given range of multicast grouping metrics. The multicast subgroup the STA 115-j is assigned to may be associated with a given multicast streaming rate. AP 105-d may define any number of multicast subgroups for assignment based at least in part on the number of STA 115 within its geographic coverage area, the positioning of the individual STA 115, a congestion level of AP 105-d, etc.

At 530, AP 105-d may transmit one or more multicast transmissions to the STA 115-j at the streaming rate associated with the assigned multicast subgroup. Accordingly, AP 105-d may provide multicast content transmissions to the STA 115-j at a streaming rate that is more reflective of the optimal streaming rate the STA 115-j is able to support, given its associated channel conditions and data rate capability.

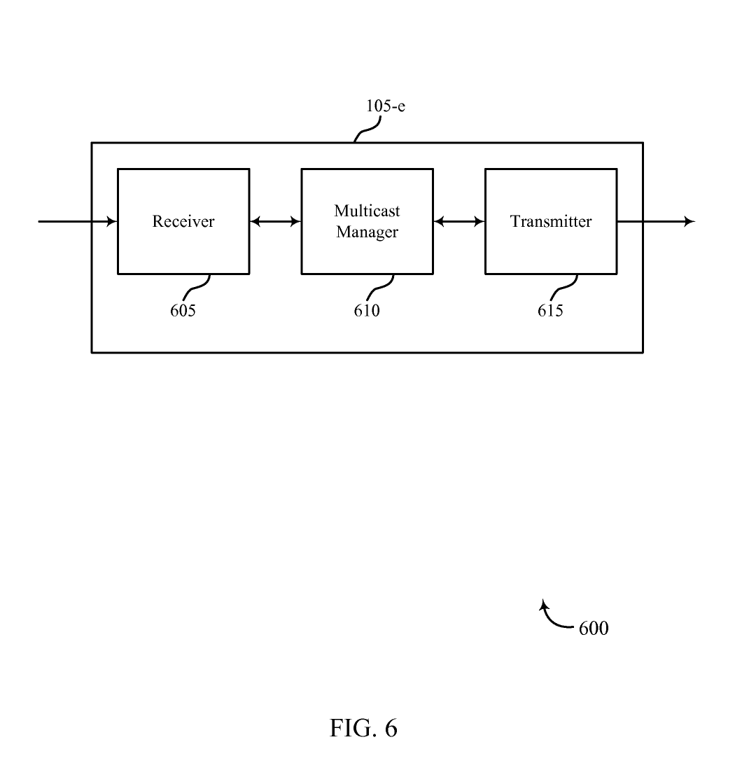

FIG. 6 shows a block diagram 600 of a device 105-e for use in an AP for wireless communication, in accordance with various aspects of the present disclosure. The device 105-e may be an example of one or more aspects of a APs 105 described with reference to FIGS. 1-5. The device 105-e may include a receiver 605, a multicast manager 610, and/or a transmitter 615. The multicast manager 610 may be an example of the multicast manager 130 described with reference to FIG. 1. The device 105-e may also be or include a processor (not shown). Each of these modules may be in communication with each other.

The device 105-e, through the receiver 605, the multicast manager 610, and/or the transmitter 615, may be configured to perform functions described herein. For example, the device 105-e may be configured to group wireless station(s) into one of a plurality of multicast subgroups based at least in part on the channel conditions associated with the wireless station as well as the data rate capability of the wireless station.

The components of the device 105-e may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The receiver 605 may receive information such as packets, user data, and/or control information associated with various information channels (e.g., control channels, data channels, etc.). The receiver 605 may be configured to receive transmissions from a wireless station associated with channel conditions associated with the wireless station, a data (or streaming) rate capability of the wireless station, etc. Information may be passed on to the multicast manager 610, and to other components of the device 105-e.

The multicast manager 610 may monitor, control, or otherwise manage aspects of multicast subgrouping of wireless stations for the device 105-e. The multicast manager 610 may manage aspects of determining a multicast grouping metric for the wireless stations within its geographic coverage area. The multicast grouping metric may be a comprehensive indicator of a streaming rate for multicast transmissions to the wireless station and may be based at least in part on the channel conditions associated with the wireless station and the data rate capability of the wireless station. The multicast manager 610 may assign the wireless station to at least one multicast subgroup based at least in part on the multicast grouping metric. The multicast manager 610 may define any number of multicast subgroups for assignment. The multicast manager 610 may, alone or in cooperation with the transmitter 615, transmit multicast transmissions to the wireless station at a streaming rate based at least in part on the assigned multicast subgroup of the wireless station. The multicast manager 610 may stream multicast content at different streaming rates to wireless stations assigned to different multicast subgroups.

The transmitter 615 may transmit the one or more signals received from other components of the device 105-e. The transmitter 615 may transmit multicast content at different streaming rates to different multicast subgroups. In some examples, the transmitter 615 may be collocated with the receiver 605 in a transceiver module.

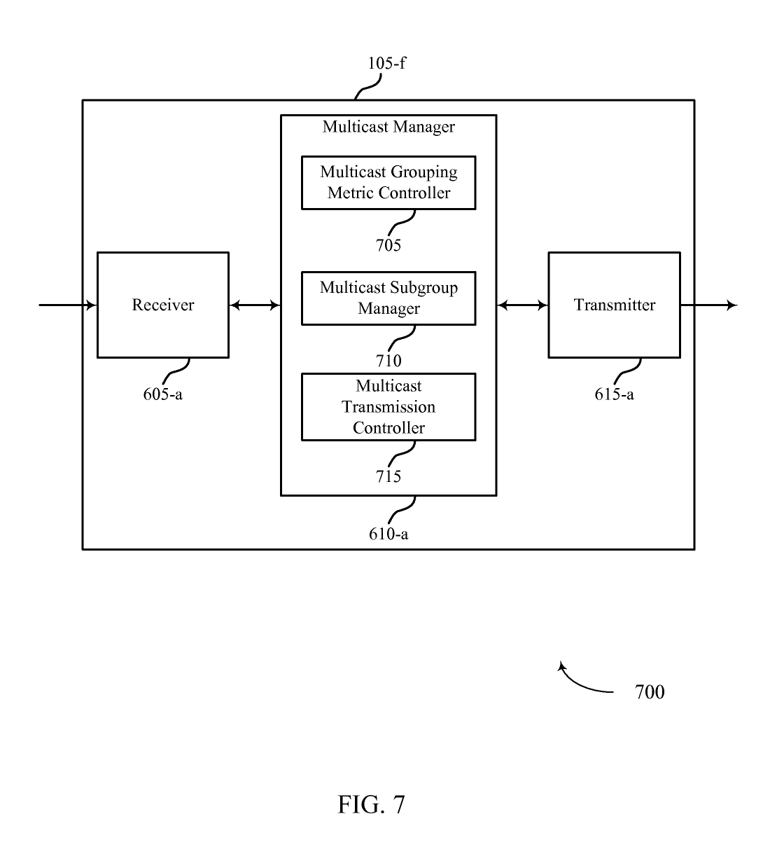

FIG. 7 shows a block diagram 700 of a device 105-f that is used in an AP for wireless communication, in accordance with various examples. The device 105-f may be an example of one or more aspects of a APs 105 described with reference to FIGS. 1-5. It may also be an example of a device 105 described with reference to FIG. 6. The device 105-f may include a receiver 605-a, a multicast manager 610-a, and/or a transmitter 615-a, which may be examples of the corresponding modules of device 105-e of FIG. 6. The device 105-f may also include a processor (not shown). Each of these modules may be in communication with each other. The multicast manager 610-a may include a multicast grouping metric controller 705, a multicast subgroup manager 710, and/or a multicast transmission controller 715. The receiver 605-a and the transmitter 615-a may perform the functions of the receiver 605 and the transmitter 615, of FIG. 6, respectively.

The multicast grouping metric controller 705 may monitor, control, or otherwise manage aspects of multicast grouping metric determinations for the device 105-f. The multicast grouping metric controller 705 may determine a multicast grouping metric for a wireless station. The multicast grouping metric may be based at least in part on a channel condition associated with the wireless station and a data rate capability of the wireless station. The multicast grouping metric controller 705 may determine the multicast grouping metric over a predetermined time period. The data rate capability for the wireless station may be based at least in part on a maximum or fastest streaming rate the wireless station is adapted to support, e.g., based at least in part on the wireless station hardware, software, firmware, subscription level, and the like.

The multicast grouping metric controller 705 may also determine the multicast grouping metric for the wireless station based at least in part on a signal strength for the wireless station (e.g., reported RSSI level), a PER for communications with the wireless station (e.g., a peak or average PER within a time period), a number of ACK/NACK messages received from the wireless station, a length of a message retransmission for communications with the wireless station, and the like. Accordingly, the multicast grouping metric controller 705 may consider a broad range of channel conditions associated with the wireless station when determining the multicast grouping metric.

The multicast grouping metric controller 705 may determine that the multicast grouping metric for the wireless station has changed. For example, the multicast grouping metric controller 705 may determine that the channel condition associated with the wireless station has changed by a predetermined amount and, therefore, determine a changed multicast grouping metric for the wireless station. The multicast grouping metric controller 705 may output information indicative of the multicast grouping metric or the changed multicast grouping metric for the wireless station.

The multicast grouping metric controller 705 may determine a multicast grouping metric for each of a plurality of wireless stations. The multicast grouping metric controller 705 may determine the multicast grouping metric for each wireless station with a geographic coverage area of the device 105-e, or at least those wireless stations interested in receiving multicast transmissions from the device 105-e.

The multicast subgroup manager 710 may monitor, control, or otherwise manage aspects of multicast subgroup assignment for the device 105-f. The multicast subgroup manager 710 may assign the wireless station to at least one of a plurality of multicast subgroups based at least in part on the multicast grouping metric for the wireless station. For example, the multicast subgroup manager 710 may define one or more multicast subgroups for multicast content transmissions. The number of multicast subgroups may be based at least in part on the number of wireless stations interested in receiving multicast transmissions, the location of the interested wireless stations within the geographic coverage area of the device 105-e, the number of available carriers or frequency bands available for multicast transmissions, the congestion level of the device 105-e, etc. The multicast subgroup manager 710 may change, periodically or dynamically, the number of available multicast subgroups depending on various changing conditions, as described above.

Each multicast subgroup may be associated with a predetermined range of multicast grouping metrics. For example, each wireless station with a multicast grouping metric within the range of multicast grouping metrics may be assigned to the associated multicast subgroup. Moreover, each multicast subgroup may be associated with a different streaming rate.

The multicast subgroup manager 710 may change the multicast subgroup the wireless station is assigned to based at least in part on a changed multicast grouping metric. The multicast subgroup manager 710 may receive information from the multicast grouping metric controller 705 indicating the changed multicast grouping metric and re-assign the wireless station to a different multicast subgroup accordingly.

In the instance where the multicast grouping metric controller 705 determines multicast grouping metrics for each of a plurality of wireless stations, the multicast subgroup manager 710 may assign each wireless station to at least multicast subgroup based at least in part on their respective multicast grouping metric.

The multicast transmission controller 715 may monitor, control, or otherwise manage aspects of multicast transmission for the device 105-f. The multicast transmission controller 715 may, alone or in cooperation with the transmitter 615-a, transmitting multicast transmissions to the wireless station at a streaming rate based at least in part on the assigned multicast subgroup. As mentioned, each multicast subgroup may be associated with a different streaming rate and therefore the multicast transmission controller 715 may manage aspects of streaming multicast content to each multicast subgroup at its associated streaming rate.

The multicast transmission controller 715 may transmit a signal or message to the wireless station indicating which multicast subgroup it has been assigned (or re-assigned) to. The multicast transmission controller 715 may transmit the message to the wireless station a predetermined number of beacon transmissions prior to starting the multicast transmission.

The multicast transmission controller 715 may also determine that the wireless station has been idle for predetermined time period and therefore initiate a polling procedure to confirm the assigned multicast subgroup assignment is still valid. For example, the multicast transmission controller 715 may send a polling message to the wireless station to solicit a transmission from the wireless station. The wireless station responding to the polling message may provide an opportunity for the multicast grouping metric controller 705 to determine (or confirm) the multicast grouping metric for the wireless station. This may provide for the multicast subgroup manager 710 to determine (or confirm) the wireless station is assigned to the appropriate multicast subgroup.

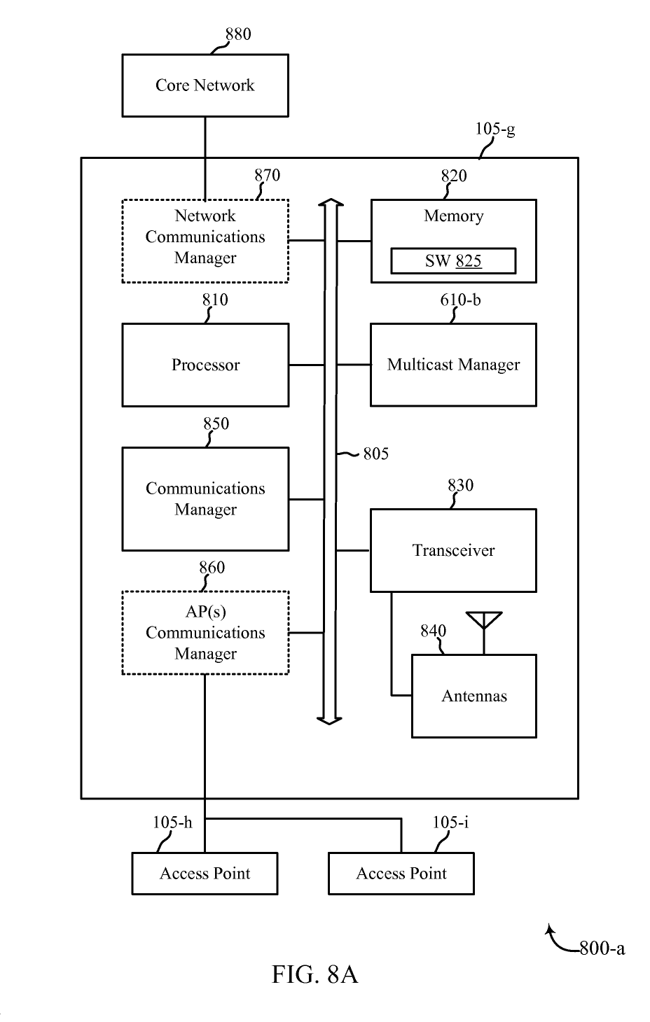

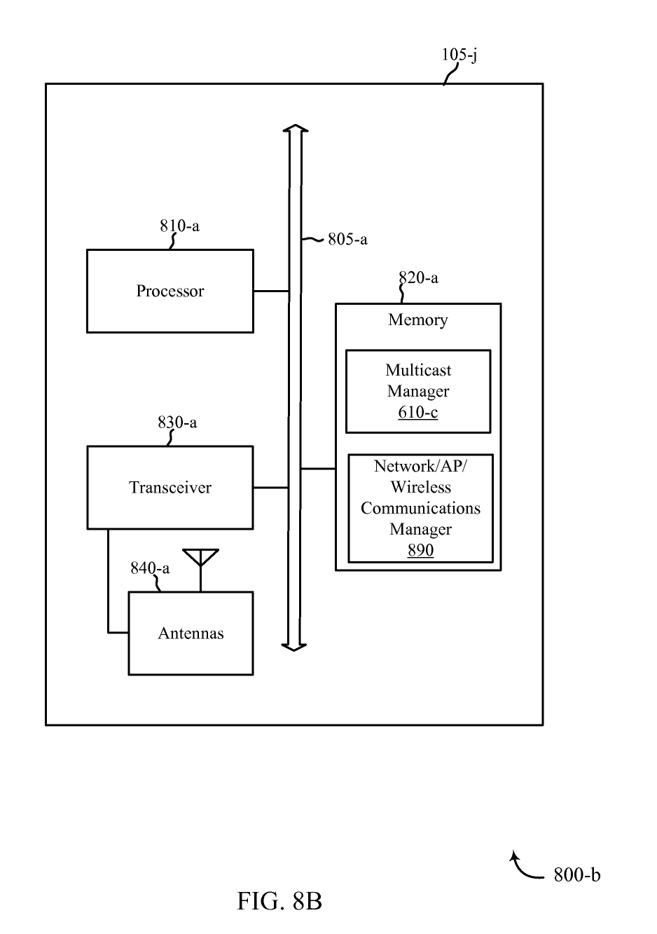

FIG. 8A shows a block diagram of a system 800-a including AP 105-g configured for multicast subgrouping delivery, a plurality of APs 105-h, 105-i, and a core network 880, in accordance with various aspects of the present disclosure. AP 105-g may be an example of an AP 105 described with reference to FIGS. 1-5, or an example of a device described with reference to FIGS. 6-7. AP 105-g may include a multicast manager 610-b, which may be an example of a multicast manger as described with reference to FIGS. 1 and 6-7. The multicast manager 610-b may perform the functions described above with reference to FIGS. 6 and 7.

AP 105-g may determine a multicast grouping metric for wireless stations. The multicast grouping metric may be determined based at least in part on channel conditions associated with the wireless station and a data rate capability of the wireless station. AP 105-g may assign the wireless station to a multicast subgroup based at least in part on the multicast grouping metric. AP 105-g may transmit multicast transmissions to the wireless station based at least in part on the assigned multicast subgroup.

The components of the AP 105-g may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In some cases, AP 105-g may have one or more wired backhaul links. AP 105-g may have a wired backhaul link (e.g., S1 interface, etc.) to the core network 880. AP 105-g may also communicate with other base stations 105-h and 105-i via inter-base station backhaul links. Each of the APs 105 may communicate with STAs 115 using the same or different wireless communications technologies. In some cases, AP 105-g may communicate with other APs utilizing AP communications manager 860. In some examples, AP communications manager 860 may provide an X2 interface within an LTE/LTE-A wireless communication network technology to provide communication between some of the APs 105. In some cases, AP 105-g may communicate with the core network 880 through network communications manager 870.

AP 105-g may include a processor 810, memory 820 (including software (SW) 825), transceiver(s) 830, and antenna(s) 840, which each may be in communication, directly or indirectly, with one another (e.g., over a bus 805). The transceiver(s) 830 may be configured to communicate bi-directionally, via the antenna(s) 840, with the STAs 115, which may be wireless stations. The transceiver(s) 830 (or other components of AP 105-g) may also be configured to communicate bi-directionally, via the antenna(s) 840, with other APs 105-h and 105-i. The transceiver(s) 830 may include a modem configured to modulate the packets and provide the modulated packets to the antennas 840 for transmission, and to demodulate packets received from the antennas 840. AP 105-g may include multiple transceivers 830, each with one or more associated antennas 840. The transceiver(s) may be an example of a combined receiver 605 and transmitter 615 of FIG. 6.

The memory 820 may include RAM and ROM. The memory 820 may also store computer-readable, computer-executable software code 825 containing instructions that are configured to, when executed, cause the processor 810 to perform various functions described herein (e.g., enhanced multicast delivery etc.). Alternatively, the computer-executable software code 825 may not be directly executable by the processor 810 but be configured to cause (e.g., when compiled and executed) a computer to perform functions described herein. The processor 810 may include an intelligent hardware device (e.g., a CPU, a microcontroller, an ASIC, etc.). The processor 810 may include various special purpose processors such as encoders, queue processing modules, base band processors, radio head controllers, DSPs, and the like.

The AP communications manager 860 may manage communications with other APs 105, e.g., APs 105-h and 105-i. The AP communications manager 860 may include a controller or scheduler for controlling communications with STAs 115 in cooperation with other APs 105. For example, the AP communications manager 860 may coordinate scheduling for transmissions to STAs 115 for various multicast transmissions at different streaming rates to different multicast subgroups.

FIG. 8B shows a block diagram of a system 800-b including AP 105-j configured for multicast subgrouping, in accordance with various aspects of the present disclosure. AP 105-j may be an example of an AP 105 described with reference to FIGS. 1-5, or an example of a device described with reference to FIGS. 6-7.

AP 105-j may include a processor 810-a, memory 820-a, transceiver 830-a, and antenna(s) 840-a, each of which may perform the functions described above with reference to FIG. 8A. In the present example, the memory 820-a may include software that performs the functionality of multicast manager 610-c and network/AP/Wireless communications manager 890. For example, memory 820-a may include software that, when compiled and executed, performs the functionality of an multicast grouping metric controller 705, a multicast subgroup manager 710, and a multicast transmission controller 715, such as described with reference to FIG. 7. In some cases, a subset of the functionality of multicast manager 610-c is included in memory 820-a; in other cases, all of the functionality may be implemented as software executed by the processor 810-a to cause the AP 105-j to perform the functions of multicast manager 610-c. For example, the functionality of the multicast grouping metric controller 705 and the multicast subgroup manager 710 may be accomplished by software included memory 820-a, while the functionality of the multicast transmission controller 715 may be accomplished using hardware.

Other combinations of hardware/software to perform the functions of multicast manager 610-c may be used. In the present example, the functions of an AP communications manager 860 may also be embodied as software stored in memory 820-a and executable by the processor 810-a. The AP communications manager 860 may manage communications with other APs 105. The AP communications manager 860 may include a controller or scheduler for controlling communications with STAs 115 in cooperation with other APs 105. For example, the AP communications manager 860 may coordinate scheduling for transmissions to STAs 115 for various multicast transmission techniques.

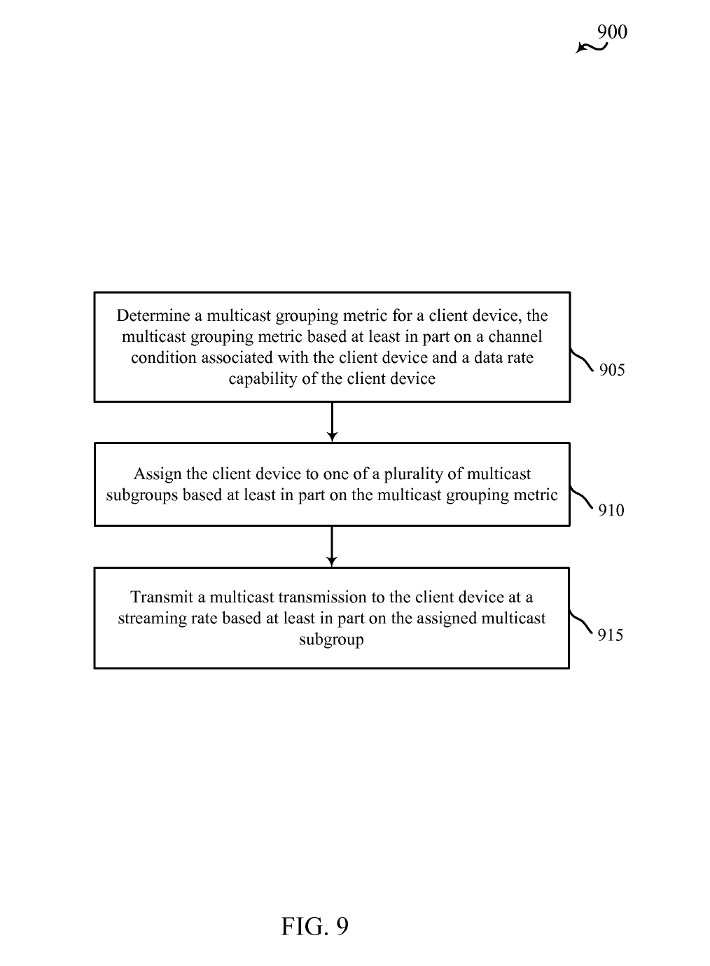

FIG. 9 shows a flowchart illustrating a method 900 for multicast transmissions in accordance with various aspects of the present disclosure. The operations of method 900 may be implemented by an AP 105 or its components as described with reference to FIGS. 1-8B. For example, the operations of method 900 may be performed by the multicast manager 610 as described with reference to FIGS. 1 and 6-8B. In some examples, an AP 105 may execute a set of codes to control the functional elements of the AP 105 to perform the functions described below. Additionally or alternatively, the AP 105 may perform aspects the functions described below using special-purpose hardware.

At block 905, the method 900 may include the AP determining a multicast grouping metric for a wireless station. The multicast grouping metric may be based at least in part on a channel condition associated with the wireless station and a data rate capability of the wireless station. The multicast grouping metric may provide a comprehensive indication of the streaming rate for multicast transmissions for the wireless station. The channel condition associated with the wireless station may include or otherwise be based at least in part on a RSSI value, a CQI indicator, a PER for the wireless station, a quantity or frequency of ACK/NACK messages received from the wireless station, etc. The data rate capability of the wireless station may be based at least in part on a hardware configuration of the wireless station, a software/firmware version of the wireless station, a subscription level for the wireless station, etc.

At block 910, the method 900 may include the AP assigning the wireless station to one or a plurality of multicast subgroups based at least in part on the multicast grouping metric of the wireless station. Each multicast subgroup may have an associated streaming rate where the streaming rates are different for each multicast subgroup.

At block 915, the method 900 may include the AP transmitting a multicast transmission to the wireless station at a streaming rate based at least in part on the assigned multicast subgroup. For example, the streaming rate may be associated with the assigned multicast subgroup and all wireless stations assigned to the multicast subgroup may receive the multicast transmission at the same streaming rate. Wireless stations assigned to different multicast subgroups may receive multicast transmissions at different streaming rates.

The operation(s) at blocks 905, 910, and 915 may be performed using the multicast manager 130 and 610 described with reference to FIGS. 1 and 6-8B.

Thus, the method 900 may provide for wireless communication. It should be noted that the method 900 is just one implementation and that the operations of the method 900 may be rearranged or otherwise modified such that other implementations are possible.

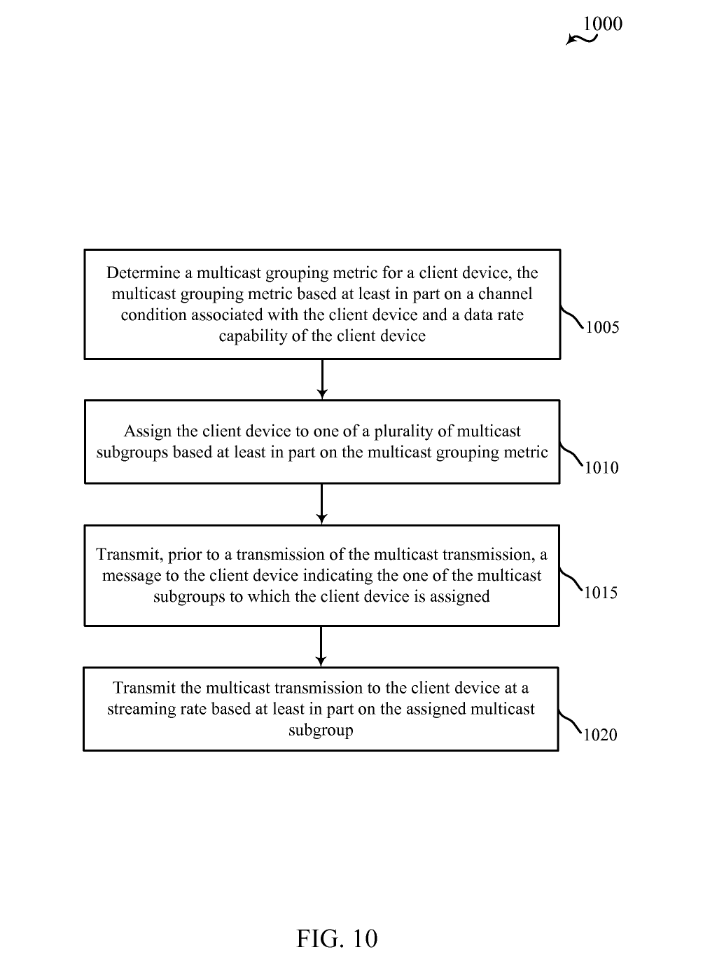

FIG. 10 shows a flowchart illustrating a method 1000 for multicast transmissions in accordance with various aspects of the present disclosure. The operations of method 1000 may be implemented by an AP 105 or its components as described with reference to FIGS. 1-8B. For example, the operations of method 1000 may be performed by the multicast manager 610 as described with reference to FIGS. 1 and 6-8B. In some examples, an AP 105 may execute a set of codes to control the functional elements of the AP 105 to perform the functions described below. Additionally or alternatively, the AP 105 may perform aspects the functions described below using special-purpose hardware.

At block 1005, the method 1000 may include the AP determining a multicast grouping metric for a wireless station. The multicast grouping metric may be based at least in part on a channel condition associated with the wireless station and a data rate capability of the wireless station. The multicast grouping metric may provide a comprehensive indication of the streaming rate for multicast transmissions for the wireless station.

At block 1010, the method 1000 may include the AP assigning the wireless station to one or a plurality of multicast subgroups based at least in part on the multicast grouping metric of the wireless station. Each multicast subgroup may have an associated streaming rate where the streaming rates are different for each multicast subgroup.

At block 1015, the method 1000 may include the AP transmitting, prior to a transmission of the multicast transmission, a message to the wireless station indicating the one of the multicast subgroups to which the wireless station is assigned. The message may be sent a predetermined number of beacon signals prior to the multicast transmission and may include an information element indicating the multicast subgroup assignment.

At block 1020 the method 1000 may include the AP transmitting the multicast transmission to the wireless station at a streaming rate based at least in part on the assigned multicast subgroup. For example, the streaming rate may be associated with the assigned multicast subgroup and all wireless stations assigned to the multicast subgroup may receive the multicast transmission at the same streaming rate. Wireless stations assigned to different multicast subgroups may receive multicast transmissions at different streaming rates.

The operation(s) at blocks 1005, 1010, 1015, and 1020 may be performed using the multicast manager 130 and 610 described with reference to FIGS. 1 and 6-8B.

Thus, the method 1000 may provide for wireless communication. It should be noted that the method 1000 is just one implementation and that the operations of the method 1000 may be rearranged or otherwise modified such that other implementations are possible.

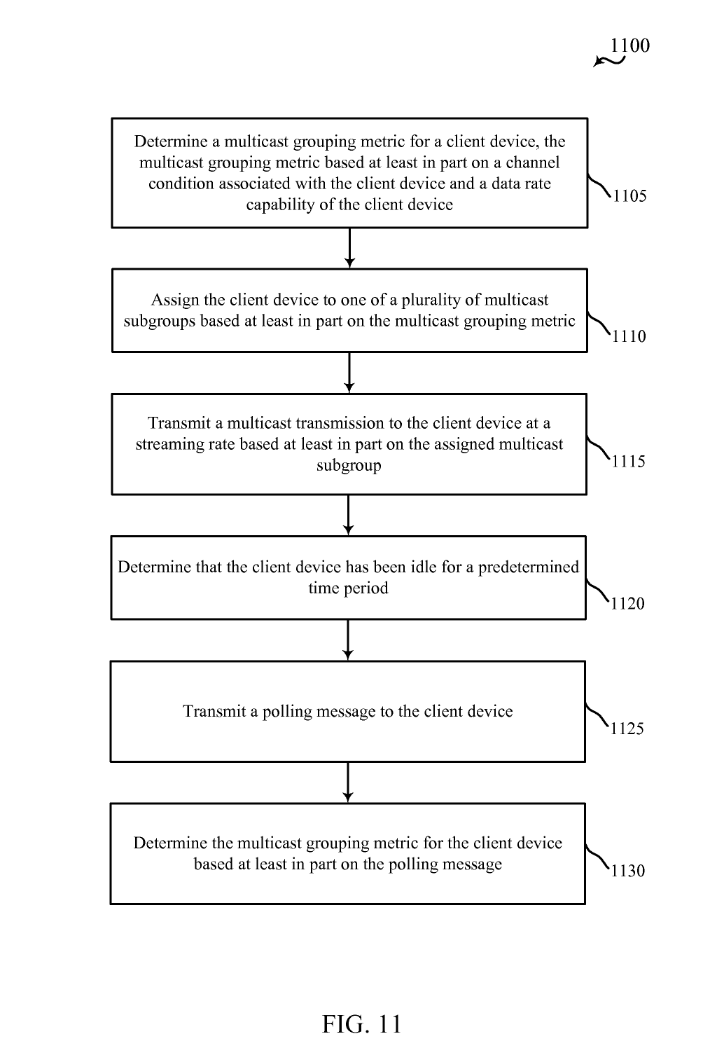

FIG. 11 shows a flowchart illustrating a method 1100 for multicast transmissions in accordance with various aspects of the present disclosure. The operations of method 1100 may be implemented by an AP 105 or its components as described with reference to FIGS. 1-8B. For example, the operations of method 1100 may be performed by the multicast manager 610 as described with reference to FIGS. 1 and 6-8B. In some examples, an AP 105 may execute a set of codes to control the functional elements of the AP 105 to perform the functions described below. Additionally or alternatively, the AP 105 may perform aspects the functions described below using special-purpose hardware.

At block 1105, the method 1100 may include the AP determining a multicast grouping metric for a wireless station. The multicast grouping metric may be based at least in part on a channel condition associated with the wireless station and a data rate capability of the wireless station. The multicast grouping metric may provide a comprehensive indication of the streaming rate for multicast transmissions for the wireless station.

At block 1110, the method 1100 may include the AP assigning the wireless station to one or a plurality of multicast subgroups based at least in part on the multicast grouping metric of the wireless station. Each multicast subgroup may have an associated streaming rate where the streaming rates are different for each multicast subgroup.

At block 1115 the method 1100 may include the AP transmitting a multicast transmission to the wireless station at a streaming rate based at least in part on the assigned multicast subgroup. For example, the streaming rate may be associated with the assigned multicast subgroup and all wireless stations assigned to the multicast subgroup may receive the multicast transmission at the same streaming rate. Wireless stations assigned to different multicast subgroups may receive multicast transmissions at different streaming rates.

At block 1120, the method 1100 may include the AP determining that the wireless station has been idle for a predetermined time period. For example, the AP may determine that no transmissions have been received from the wireless station within the predetermined time period. Accordingly, the AP may initiate a polling procedure to confirm or update the multicast grouping metric and multicast subgroup assignment for the wireless station.

At block 1125, the method 1100 may include the AP transmitting a polling message to the wireless station. The polling message may solicit a response transmission from the wireless station. At block 1130, the method 1100 may include determining the multicast grouping metric for the wireless station based at least in part on the polling message. For example, the AP may determine that the channel conditions for the wireless station, based at least in part on the response transmission solicited by the polling message, are the same or have changed. Accordingly, the AP may determine the an updated multicast grouping metric for the wireless station or at least confirming that the current multicast grouping metric for the wireless station remains valid.

The operation(s) at blocks 1105, 1110, 1115, 1120, 1125, and 1130 may be performed using the multicast manager 130 and 610 described with reference to FIGS. 1 and 6-8B.

Thus, the method 1100 may provide for wireless communication. It should be noted that the method 1100 is just one implementation and that the operations of the method 1100 may be rearranged or otherwise modified such that other implementations are possible.

In some examples, aspects from two or more of the methods 900-1100 may be combined. It should be noted that the methods 900, 1000, etc. are just example implementations, and that the operations of the methods 900-1100 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
determining a multicast grouping metric for a wireless station, the multicast grouping metric based at least in part on a channel condition associated with the wireless station and a data rate capability of the wireless station;
assigning the wireless station to one of a plurality of multicast subgroups based at least in part on the multicast grouping metric; and
transmitting a multicast transmission to the wireless station at a streaming rate based at least in part on the assigned multicast subgroup.

2. The method of claim 1, further comprising:
determining the multicast grouping metric for the wireless station over a predetermined time period.

3. The method of claim 1, further comprising:
transmitting, prior to transmission of the multicast transmission, a message to the wireless station indicating the one of the multicast subgroups to which the wireless station is assigned.

4. The method of claim 1, further comprising:
determining that the multicast grouping metric for the wireless station has changed; and
assigning the wireless station to a different multicast subgroup based at least in part on the changed multicast grouping metric.

5. The method of claim 1, further comprising:
determining the plurality of multicast subgroups based at least in part on multicast grouping metrics associated with a plurality of wireless stations within a coverage area of an access point; and
transmitting multicast messages to different ones of the multicast subgroups using different streaming rates.

6. The method of claim 1, wherein the data rate capability of the wireless station is based at least in part on a maximum streaming rate the wireless station is adapted to support.

7. The method of claim 1, wherein the multicast grouping metric is further based at least in part on a signal strength for the wireless station, a packet error rate for communications with the wireless station, a quantity of acknowledgement or negative acknowledgement (ACK/NACK) messages received from the wireless station, a message retransmission length for communications with the wireless station, or combinations thereof.

8. The method of claim 1, further comprising:
determining that the wireless station has been idle for a predetermined time period;
transmitting a polling message to the wireless station; and
determining the multicast grouping metric for the wireless station based at least in part on the polling message.

9. An apparatus for wireless communications, comprising:
a multicast grouping metric controller to determine a multicast grouping metric for a wireless station, the multicast grouping metric based at least in part on a channel condition associated with the wireless station and a data rate capability of the wireless station;
a multicast subgroup manager to assign the wireless station to one of a plurality of multicast subgroups based at least in part on the multicast grouping metric; and
a multicast transmission controller to transmit a multicast transmission to the wireless station at a streaming rate based at least in part on the assigned multicast subgroup.

10. The apparatus of claim 9, wherein the multicast grouping metric controller is further to determine the multicast grouping metric for the wireless station over a predetermined time period.

11. The apparatus of claim 9, wherein the multicast transmission controller is further to transmit, prior to transmission of the multicast transmission, a message to the wireless station indicating the one of the multicast subgroups to which the wireless station is assigned.

12. The apparatus of claim 9, wherein the multicast grouping metric controller is further to determine that the multicast grouping metric for the wireless station has changed; and
wherein the multicast subgroup manager is further to assign the wireless station to a different multicast subgroup based at least in part on the changed multicast grouping metric.

13. The apparatus of claim 9, wherein the multicast subgroup manager is further to determine the plurality of multicast subgroups based at least in part on multicast grouping metrics associated with a plurality of wireless stations within a coverage area of an access point; and
wherein the multicast transmission controller is further to transmit multicast messages to different ones of the multicast subgroups using different streaming rates.

14. The apparatus of claim 9, wherein the data rate capability of the wireless station is based at least in part on a maximum streaming rate the wireless station is adapted to support.

15. The apparatus of claim 9, wherein the multicast grouping metric is further based at least in part on a signal strength for the wireless station, a packet error rate for communications with the wireless station, a quantity of acknowledgement or negative acknowledgement (ACK/NACK) messages received from the wireless station, a message retransmission length for communications with the wireless station, or combinations thereof.

16. The apparatus of claim 9, wherein the multicast transmission controller is further to determine that the wireless station has been idle for a predetermined time period;
to transmit a polling message to the wireless station; and
wherein the multicast grouping metric controller is further to determine the multicast grouping metric for the wireless station based at least in part on the polling message.

17. An apparatus for wireless communication, comprising:
means for determining a multicast grouping metric for a wireless station, the multicast grouping metric based at least in part on a channel condition associated with the wireless station and a data rate capability of the wireless station;
means for assigning the wireless station to one of a plurality of multicast subgroups based at least in part on the multicast grouping metric; and
means for transmitting a multicast transmission to the wireless station at a streaming rate based at least in part on the assigned multicast subgroup.

18. The apparatus of claim 17, further comprising:
means for determining the multicast grouping metric for the wireless station over a predetermined time period.

19. The apparatus of claim 17, further comprising:
means for transmitting, prior to transmission of the multicast transmission, a message to the wireless station indicating the one of the multicast subgroups to which the wireless station is assigned.

20. The apparatus of claim 17, further comprising:
means for determining that the multicast grouping metric for the wireless station has changed; and
means for assigning the wireless station to a different multicast subgroup based at least in part on the changed multicast grouping metric.

21. The apparatus of claim 17, further comprising:
means for determining the plurality of multicast subgroups based at least in part on multicast grouping metrics associated with a plurality of wireless stations within a coverage area of an access point; and
means for transmitting multicast messages to different ones of the multicast subgroups using different streaming rates.

22. The apparatus of claim 17, wherein the data rate capability of the wireless station is based at least in part on a maximum streaming rate the wireless station is adapted to support.

23. The apparatus of claim 17, wherein the multicast grouping metric is further based at least in part on a signal strength for the wireless station, a packet error rate for communications with the wireless station, a quantity of acknowledgement or negative acknowledgement (ACK/NACK) messages received from the wireless station, a message retransmission length for communications with the wireless station, or combinations thereof.

24. The apparatus of claim 17, further comprising:
means for determining that the wireless station has been idle for a predetermined time period;
means for transmitting a polling message to the wireless station; and
means for determining the multicast grouping metric for the wireless station based at least in part on the polling message.

25. A non-transitory computer-readable medium storing code for communication at a wireless device, the code comprising instructions executable by a processor to cause the wireless device to:
determine a multicast grouping metric for a wireless station, the multicast grouping metric based at least in part on a channel condition associated with the wireless station and a data rate capability of the wireless station;
assign the wireless station to one of a plurality of multicast subgroups based at least in part on the multicast grouping metric; and
transmit a multicast transmission to the wireless station at a streaming rate based at least in part on the assigned multicast subgroup.

26. The non-transitory computer-readable medium of claim 25, further comprising code executable by the processor to:
determine the multicast grouping metric for the wireless station over a predetermined time period.

27. The non-transitory computer-readable medium of claim 25, further comprising code executable by the processor to
transmit, prior to transmission of the multicast transmission, a message to the wireless station indicating the one of the multicast subgroups to which the wireless station is assigned.

28. The non-transitory computer-readable medium of claim 25, further comprising code executable by the processor to:
determine that the multicast grouping metric for the wireless station has changed; and
assign the wireless station to a different multicast subgroup based at least in part on the changed multicast grouping metric.

29. The non-transitory computer-readable medium of claim 25, further comprising code executable by the processor to:
determine the plurality of multicast subgroups based at least in part on multicast grouping metrics associated with a plurality of wireless stations within a coverage area of an access point; and
transmit multicast messages to different ones of the multicast subgroups using different streaming rates.

30. The non-transitory computer-readable medium of claim 25, wherein the data rate capability of the wireless station is based at least in part on a maximum streaming rate the wireless station is adapted to support.
